(19) United States
(12) Patent Application Publication
(10) Pub. No.: US 2002/0040353 A1
(43) Pub. Date: Apr. 4, 2002

(54) Method and system for a user obtaining stamps over a communication network

(75) Inventors: L. Carlton Brown JR., Warrenton, VA (US); Alan Ismail, Pittsburgh, PA (US); J. P. Leon, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Neopost Inc., Hayward, CA

(21) Appl. No.: 09/902,479

(22) Filed: Jul. 9, 2001

Related U.S. Application Data
(63) Continuation-in-part of application No. 09/708,883, filed on Nov. 7, 2000.
(60) Provisional application No. 60/216,779, filed on Jul. 7, 2000.
(60) Provisional application No. 60/216,653, filed on Jul. 7, 2000.
(60) Provisional application No. 60/206,207, filed on May 22, 2000.
(60) Provisional application No. 60/204,357, filed on May 15, 2000.
(60) Provisional application No. 60/181,299, filed on Feb. 9, 2000.
(60) Provisional application No. 60/181,368, filed on Feb. 8, 2000.
(60) Provisional application No. 60/165,885, filed on Nov. 16, 1999.
(60) Provisional application No. 60/164,639, filed on Nov. 10, 1999.

(51) Int. Cl. G06F 17/00

(52) U.S. Cl. 705/401

(57) ABSTRACT

Techniques are provided for obtaining postage at a user system from a central server, for example, a Postal Vendor System (PVS), via a communications network, such as the Internet or an intra-net. A print program processes a markup language, for example, an extensible Markup Language (XML) or a Standard Generalized Markup Language (SGML) message in order to print an indicium or indicia received from the central server.

U.S. Non-Provisional Patent Application No. 09/708,971, entitled “Providing Stamps on Secure Paper Using a Communications Network,” by J.P. Leon, et. al., filed Nov. 7, 2000.

### BACKGROUND OF THE INVENTION

The present invention relates generally to postage dispensing systems, and more particularly to techniques for obtaining postage by a user from a computer system using a communication network.

Traditionally, consumers could purchase postage or stamps only from special locations designated by a postal authority. For example, in the U.S., consumers could buy postage only from post offices or other centers specifically authorized by the United States Postal Service (USPS) to sell postage. A disadvantage of this traditional postage buying method is that a consumer has to spend the time and make the effort to physically travel to the post office to buy postage.

In order to alleviate the inconveniences associated with traditional techniques described above, postal authorities such as the USPS, now allow postage to be printed by electromechanical postage meters which can be placed at the consumers' or users' premises. Such postage meters can be leased, rented, or purchased where allowed, from the postal authority or from vendors, such as Neopost Inc., who have been authorized by the postal authority to sell the meters. Typically, the user purchases a fixed amount of postage value beforehand and the meter is programmed with this amount. Subsequently, the user is allowed to print postage up to the programmed amount. The meter typically includes a print mechanism and mechanical arrangements and/or electronic control circuitry that direct the operation of the print mechanism.

Because the meter is capable of printing postage having a value, the postal authority generally mandates that, in order to maintain security of the postal funds, the postage meters be acquired and used/handled according to strict, complex, and often bureaucratic regulations imposed by the postal authority. For example, a special meter agreement has to be signed between the meter vendor and the user before the meter can be rented or leased by the user. The user also has to secure a postal license number from a postal authority and the meter has to be seeded with the postal license number. A postal license number is usually associated with a geographical address of a user and is used by the postal authority to track the location of the postage meter and its user. A user using postage meters at multiple geographical addresses has to secure multiple postal licenses, one for each address. Additionally, before a new meter is put into service, the meter has to be inspected and sealed by postal authority personnel. Once in service, each meter has to be periodically inspected by postal authority representatives. Further, postal regulations mandate that the postage meter itself incorporate a variety of security features thereby increasing the costs associated with acquiring and using the meter. As a result, renting or leasing, and subsequently using a postal meter can often be expensive, inconvenient, and involve many bureaucratic hurdles. Consequently, it is quite impractical for individual users to use postage meters.

With a view towards alleviating some of the above-mentioned problems and making use of advances in electronics and communications, the United States Postal Service (USPS) has promulgated specifications for its Information Based Indicia Program (IBIP). The IBIP program supports new methods of applying postage in lieu of conventional approaches that typically rely on the use of a postage meter mechanically printing the indicium on mail pieces.

The IBIP program contemplates postal indicia printed by conventional printers (e.g., thermal, inkj et, or laser) and including human-readable and machine-readable portions. An indicium refers to the imprinted designation or a postage mark used on mail pieces denoting evidence of postage payment. The machine-readable portion was initially specified to be a two-dimensional barcode symbology known as PDF417. The indicium content includes a digital signature for security reasons (to preclude forgery). There are separate specifications for open and closed systems.

An open system is defined as a general purpose computer used for printing information-based indicia, but not dedicated to the printing of those indicia. A closed system is defined as a system whose basic components are dedicated to the production of information-based indicia and related functions, that is, a device dedicated to creating indicia similar to an existing, traditional postage meter. A closed system may be a proprietary device used alone or in conjunction with other closely related, specialized equipment, and includes the indicium print mechanism.

The IBIP program specifies a postal security device (PSD) that manages the secure postage registers and performs the cryptographic operations of creating and verifying digital signatures.

The open system specification describes a host system (a computer or postage meter) connected to an unsecured printer (e.g., a laser printer or the like) and a PSD. The host system also provides communication facilities that allow the PSD's vendor and/or the USPS to establish communications with the PSD. Communications supported include troubleshooting, accounting transactions, and the like.

The PSD and host cooperate to provide an indicium, which is then transmitted to and printed by the unsecured printer. The specified indicium allows the use of an unsecured printer (e.g., thermal, inkjet, or laser) by using a digital signature, which also supports authentication of the mail piece. The indicium includes human-readable information and machine-readable information (initially specified as a PDF417 two-dimensional bar code). Each PSD is a unique security device, having core security functions such as digital signature generation and verification and secure management of information (e.g., descending and ascending registers).

Several techniques have been developed, based on the IBIP program, to streamline and simplify the use of postage meters while providing the required security. For example, U.S. Pat. No. 6,005,945 (Whitehouse) discloses a system for electronic distribution of postage using a secure central computer which generates the postal indicia in response to postage requests submitted by end user computers. However, these conventional techniques, including the system described in the Whitehouse patent, still require the user to apply for and obtain a postal license number from a postal authority. As a result, a user still has to suffer the inconveniences and bureaucratic hurdles of obtaining postal license numbers. Further, since the issuance of postal licenses may take several days or even weeks, valuable time is wasted before a user can make use of services provided by a postage vendor.

In addition, in the Whitehouse patent, the user's request includes the destination address of the mailpiece. The central computer validates this destination address (where alternately, the destination address may have been previously validated) before generating the indicium. The indicium returned to the user includes both the mailpiece origin address and the mailpiece destination address. Thus the stamp has a targeted usage and is missing the convenience of a typical conventional US postage stamp, which is not restricted by origin or destination of the mailpiece. Of course, if the destination is far away, more stamps may be needed, but the restriction is the amount of each stamp not the particular origin and/or destination.

In light of the above, there is a need for techniques which allow a user to buy postage without suffering the inconveniences described above. It is further desirable that the techniques be operable in a distributed environment and make use of communication networks such as the Internet.

### BRIEF SUMMARY OF THE INVENTION

The present invention provides techniques for obtaining postage at a user system from a central server, for example, a Postal Vendor System (PVS), via a communications network, such as the Internet or an intra-net. In particular a print program is provided. This print program processes a markup language message in order to print an indicium or indicia received from the central server.

An embodiment of the present invention provides a method for obtaining a postage stamp by a user system (having a processor, a memory, and a printer) from a website server over a communications network, for example, the Internet. The method includes, the user system requesting the stamp from the website server. The user system then receives a markup language, e.g., SGML or XML or HTML, message having encoded binary data representing a machine-readable portion of an indicium associated with the stamp. The indicium includes a digital signature. And using a print program, the user's printer prints the machine-readable portion on a pre-processed label. The method may optionally include, storing a print program downloaded from the website server in the memory, where the print program includes, for example, an ActiveX control or print.dll (dynamic link library). The print program does not require a separate account or license from the United States Postal Service to execute. In one embodiment the print program is provided with a small footprint on the user's machine, for example, under 1 Megabyte. In an alternative embodiment the print program is not so limited in size.

Another embodiment of the present invention provides a system for obtaining a postage stamp from a central server via a communication network The system includes: a memory; a processor coupled to the memory for sending a user request for the postage stamp in XML format to the central server; an XML software module stored in the memory for extracting an indicium from an XML message received in response to the user request, the indicium including a digital signature; a print program stored in the memory, the print program preparing the indicium for printing; and a printer for printing the indicium on a pre-processed label.

Yet another embodiment of the present invention provides a computer program product stored in a computer readable medium for obtaining a postage stamp by a user system from a website server over a communications network. The user system has a processor, a memory, and a printer. The computer program product includes code for requesting the stamp from the website server; code for receiving an XML message, the XML message including encoded binary data representing a machine-readable portion of an indicium associated with the stamp, the indicium including a digital signature; and code for printing the machine-readable portion on a pre-processed label by the printer.

These and other embodiments of the present invention are described in more detail in conjunction with the text below and attached figures.

### BRIEF DESCRIPTION OF THE DRAWINGS

FIG. 1 is a simplified block diagram of a distributed computer network 100 that may incorporate an embodiment of the present invention;

FIG. 2 is a simplified high-level flowchart showing processing performed by user system and PVS for obtaining postage according to an embodiment of the present invention;

FIG. 3 illustrates a print program operating on the user computer of one embodiment of the present invention;

FIG. 4 illustrates an example of an individual pre-printed label of one embodiment of the present invention;

FIG. 5 illustrates an example of an individual postage stamp of one embodiment of the present invention;

FIG. 6 gives a simplified flowchart of the functions of the print program of one embodiment of the present invention;

FIG. 7 illustrates an example of a sheet of postage labels of an embodiment of the present invention;

FIG. 8 illustrates an example of a printed postage label sheet of an embodiment of the present invention; and

FIG. 9 illustrates a simplified flowchart of printing a sheet of stamps of an embodiment of the present invention.

### DETAILED DESCRIPTION OF THE INVENTION

The present invention provides techniques for obtaining postage using a communication network such as the Internet. In particular an embodiment of the present invention represents the client or user side of the postage system described in U.S. patent application Ser. No. 09/708,883, titled “Techniques For Dispensing Postage Using A Communication Network,” L. Carlton Brown, Jr., et. al., filed Nov. 7, 2000, which is herein incorporated by reference in its entirety.

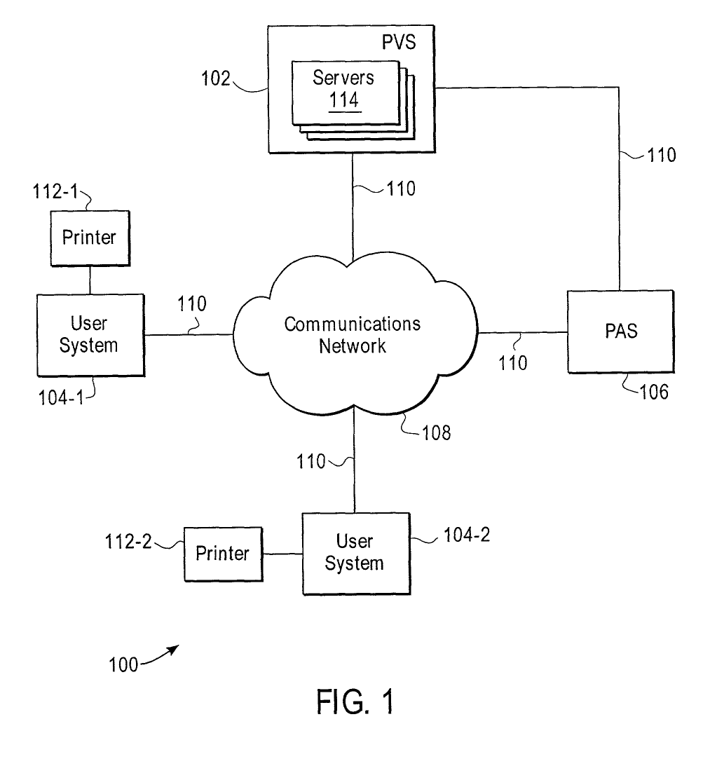

FIG. 1 is a simplified block diagram of a distributed computer network 100 that may incorporate an embodiment of the present invention. Computer network 100 includes one or more user computer systems 104-1 and 104-2, at least one postage vendor system (PVS) 102, and a postal authority system (PAS) 106 coupled to a communication network 108 via a plurality of communication links 110. User systems 104 may optionally be coupled to one or more printers 112 or other like printing devices, and other peripheral devices (not shown) such as a weighing scale.

Communication network 108 provides a mechanism for allowing the various components of distributed network 100 to communicate and exchange information with each other. Communication network 108 may itself be comprised of many interconnected computer systems and communication links, including links 110. Communication links, including those links in communication network 108, may be hardwire links, optical links, satellite or other wireless communications links, wave propagation links, or any other mechanisms for communication of information. While in one embodiment communication network 108 is the Internet, in other embodiments, communication network 108 may be any suitable computer network. Distributed computer network 100 depicted in FIG. 1 is merely illustrative of an embodiment incorporating the present invention and does not limit the scope of the invention as recited in the claims. One of ordinary skill in the art would recognize other variations, modifications, and alternatives. For example, more than one PVS 102 may be coupled to communication network 108. Further, one or more printers 112 may optionally be coupled to a single user system 104, or alternatively a plurality of user systems 104 may share one or more common printers. Other devices such as weighing machines for weighing mail pieces, fax machines, scanners, etc. may also be coupled to user systems 104.

User systems 104 allow users of an embodiment of the present invention, for example, postage consumers, to interact with and buy postage from PVS 102. These users may include one or more human beings interacting with an user system 104, one or more processes executing on user system 104 or systems coupled to user systems 104, devices coupled to user systems 104, or other entities capable of interacting with PVS 102. Various different types of interactions with PVS 102 are facilitated by user systems 104. For example, users may use user systems 104 to configure requests to purchase postage from PVS 102. These user purchase requests are then communicated from user systems 104 to PVS 102 via communication network 108. In response to the user requests, user systems 104 may receive information for printing indicia (or a single indicium) from PVS 102. A user may then use user system 104 to print the indicia using printer devices coupled to or accessible to user system 104. The indicia may be printed on labels, on paper, on the mail pieces themselves, or on other like media. In alternative embodiments of the present invention, a user using user system 104 may store the information for printing indicia received from PVS 102 on a storage medium, such as a computer disk, for subsequent printing of the indicia.

Users may also use user systems 104 to perform other activities such as browse web-pages stored by PVS 102, register as users of services provided by PVS 102, provide financial and credit information for consummating commercial transactions with PVS 102, review status of user accounts maintained by PVS 102, review postage purchase history, access help or customer services provided by PVS 102, and to perform other like activities. Accordingly, in a client-server environment, user system 104 typically operates as a client requesting information from PVS 102 which operates as a server which performs processing in response to the client request and provides the requested information to the client systems. It should be however apparent that a particular user system 104 may act both as a client or a server depending on whether the user system is requesting or providing information.

As stated above, a user may use user system 104 to browse or interact with web pages provided by PVS 102. These web pages may be stored by one or more web servers of PVS 102 and may be accessed by users of user system 104 via a browser program executing on user system 104. Examples of browser programs include the Internet Explorer browser program provided by Microsoft Corporation, the Netscape Navigator browser provided by Netscape Corporation, and others. In the Internet and World Wide Web (the “Web”) environment, the web pages may be written in the Hypertext Markup Language (HTML) or the extensible Markup Language (XML) or the Standard Generalized Markup Language (SGML), and may incorporate any combination of text, graphics, images, audio and video content, software programs, and other data. Web pages may also contain hypertext links to other web pages. Each web page is uniquely identified by an address called a Uniform Resource Locator (URL) that enables users to access the web page. Users may access web pages by providing URL information to the browser, either directly or indirectly, and in response, a web page corresponding to the user-specified URL is downloaded from a server coupled to communication network 108 to the requesting user computer 104. The downloaded web page may then be viewed by the user using the browser.

In some embodiments of the present invention, PVS 102 is responsible for dispensing postage in response to postage purchase requests received from user systems 104. As shown in FIG. 1, PVS 102 may itself be comprised of multiple interconnected computer and server systems 114 and communication links. PVS 102 may be configured to receive postage requests from user systems 104, validate the postage requests, generate information for printing indicia in response to the postage requests, perform security functions related to the postage transactions, manage funds related to the postage transactions, communicate the information for printing the indicia to the requesting user systems 104, maintain and manage user accounts, and several other functions. These functions are generally performed by software code modules executed by PVS 102. However, it should be apparent that these functions may be also performed by software modules or hardware modules of PVS 102, or combinations thereof.

According to an embodiment of the present invention, the information for printing indicia generated by PVS 102 is generally along the lines specified by the IBIP specifications published by the United States Postal Service (USPS).

In some embodiments of the present invention, a single postal license number is assigned to each PVS 102 by a postal authority such as the USPS. PVS 102 uses the single postal license number to cater to postage requests from a plurality of unrelated users who may be at different geographical addresses. Thus, in these embodiments, a single postal license number is effectively shared between a plurality of users who may have different geographical addresses. This is substantially different from conventional postage vending techniques wherein a user is required to apply for and receive at least one unique postal license number. This is the case even if the postage indicium is generated by a central computer, for example, as discussed in U.S. Pat. No. 6,005,945 (Whitehouse). Accordingly, the present invention provides a level of postage buying convenience heretofore not achieved by conventional techniques. Since the postal license number is associated with PVS 102 rather than with the user, the user is shielded from the procedural steps required for obtaining the postal license number. In fact, according to the present invention, the consumer of the postage does not even have to be aware of the postal license number. A user may buy postage by simply sending a postage request to PVS 102 and receiving information for printing one or more indicia corresponding to the request from PVS 102.

Referring back to FIG. 1, postal authority system (PAS) 106 may comprise one or more computer systems managed by a postal authority authorized to regulate and control postal matters. Examples of postal authorities include the United States Postal Service (USPS), France's La Poste, United Kingdom's Royal Mail, and others. In most instances, the postal authority is a governmental or quasi-governmental agency authorized to oversee postal matters. PAS 106 may be coupled to PVS 102 via communication network 108 or directly via some other communication link 110. The information exchanged between PVS 102 and PAS 106 may include finance information, information required by the postal authority for audit purposes, status information, security information, and other like information. The information required by the postal authority for audit purposes may include information identifying the postage buyers, the postage value and amount purchased by the buyers, and other information. PVS 102 may be configured to download information to PAS 106 on a periodic basis using batch processing, or upon the occurrence of certain events. PVS 102 may also be configured to purchase postage from PAS 106.

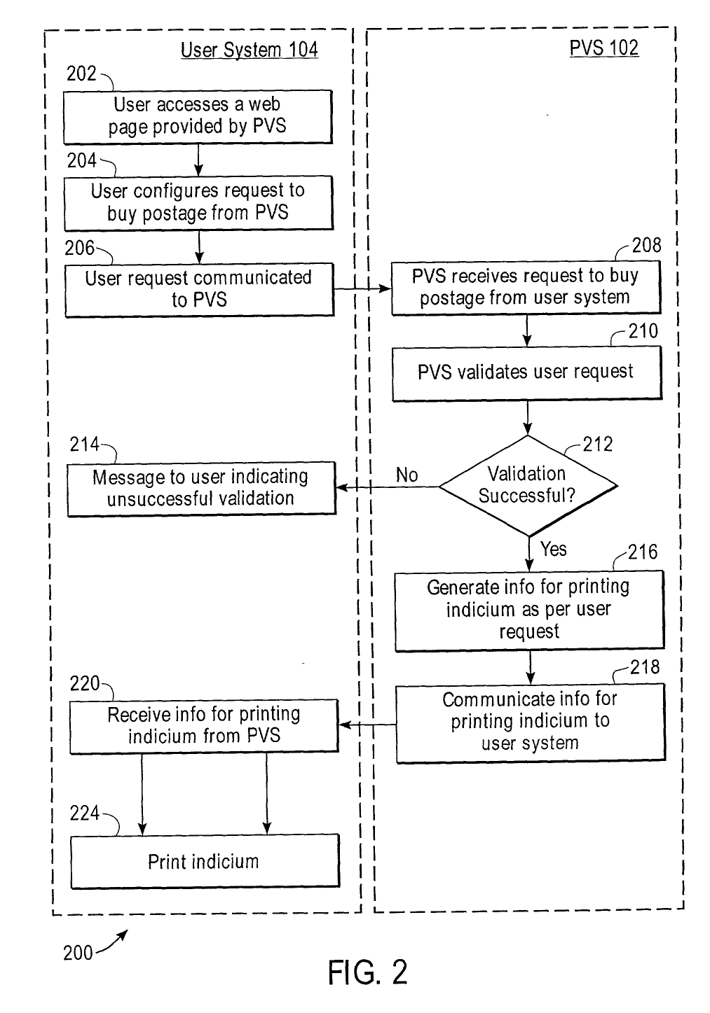

FIG. 2 is a simplified high-level flowchart 200 showing processing performed by user system 104 and PVS 102 for obtaining postage according to an embodiment of the present invention. As shown in FIG. 2, processing is generally initiated when a user accesses a web page provided by PVS 102 using user system 104 (step 202). As described above, the user may access the web pages by providing URL information corresponding to the web pages to a browser executing on user system 104. Using the web page(s), the user may then configure a request to buy postage from PVS 102 (step 204). For example, the user may request purchase of one or more $0.33 stamps. The user may also use devices connected to user system 104 to configure the request. For example, a weighing scale connected to user system 104 may be used to provide information related to the weight of the mail piece for which postage is to be purchased.

According to an embodiment of the present invention, a user may be required to first register as a user of PVS 102 and open an account with PVS 102 before the user is allowed to buy postage from PVS 102. As part of this registration process, the user may be asked to provide information to PVS 102 such as information identifying the user, credit-card or other like information which may be used by PVS 102 to bill for postage purchased by the user, and other information. The information provided by the user may be stored by PVS 102 and a unique identifier may be assigned to the user to uniquely identify the user. The user may also be allowed to select a password to access the user's account. The user may also be allowed to configure user preferences related to postage buying activities. The user may also be allowed to store funds in the account which may be used for postage purchases. It should be apparent that in alternative embodiments of the present invention, the user may be allowed to buy postage from PVS 102 without opening an account or registering with PVS 102.

The user request to purchase postage may include information identifying the user, credit-card or other like information which will be used by PVS 102 to bill for the purchased postage, the amount and value/denomination of the postage which the user wishes to purchase, and other like information which may be used by PVS 102 to process the request. A single user request may request purchase of one or more stamps. If the user is a registered user and has a pre-established account with PVS 102, the user identification information may include a user identifier assigned by PVS 102 to the user during user registration. Further, for a registered user, PVS may use information provided by the user during the registration process for billing purposes, and consequently the credit-card or other like information may not be included in the user request.

The user request may also include other information related to the mail piece/package. For example, the user request may include information related to the weight of the mail piece/package which may be used by PVS 102 to compute the exact postage value required for mailing the mail piece/package. The weight information may be directly input by the user, or may be received from devices, e.g. weighing devices, coupled to user system 104. According to an embodiment of the present invention, the user request may also comprise information identifying the medium on which the indicium (or indicia) is to be printed. For example, if the indicium is to be printed on a label or a sheet of labels, the user request may include information, such as a serial number, associated with the label or sheet of labels. The serial number may be input by the user during step 204. Alternatively, information identifying the medium may be scanned and provided to user system 104. Further details related to the use of labels and sheets of labels are provided below.

In a preferred embodiment the user request to buy postage is formed using an XML data structure. This XML purchase request for a stamp may be transmitted from user system 104 to PVS 102, and may include the following:

<server.bp_RequestWebStampParams>

<LoginID>TestPrint</LoginID>
<Amount>330</Amount>
<RateClass>1100</RateClass>
<FIM>0</FIM>
<SerialNumber>1966-F8CF</SerialNumber>
<CCNameOnCard>Joe Customer</CCNameOnCard>
<CCNumber>0000111122223333</CCNumber>
<CCExp>0401</CCExp>

</server.bp_RequestWebStampParams>

where:

<LoginD>TestPrint</LoginD> is the user's name (or login name or identifier if the user is a registered user);

<Amount>330</Amount> is the amount of postage to be purchased in 1/1000 of US dollars. For example, 330=$0.33;

<RateClass>1100</RateClass> is the value corresponding to a rate class of the postage, for example, “First Class”;

<FIM>0</FIM> is a unused legacy field which is set to zero;

<SerialNumber>1966-F8CF</SerialNumber> identifies the medium on which the indicium or indicia are to be printed. According to an embodiment of the present invention, this field identifies the serial number of the sheet of labels on which the user intends to print the indicia (assuming that the sheet of labels are serialized). This field may also identify the serial number of the label on which an indicium is to be printed. In embodiments of the present invention where both the labels and the sheets are serialized, this field may include one or more label serial numbers and one or more sheet serial numbers;

<CCNameOnCard>Joe Customer</CCNameOnCard> is the user's name as spelled on a credit card which is to be used for consummating the commercial purchase transaction. If the user is a registered user, this field may be blank and PVS 102 may use information provided by the user during registration and stored by PVS 102;

<CCNumber>0000111122223333</CCNumber> is the credit card number which the user intends to use for billing purposes. If the user is a registered user, this field may be blank and PVS 102 may use credit card information provided by the user during registration and stored by PVS 102; and

<CCExp>0401</CCExp> is the credit card expiration date of the credit card which the user intends to use for billing purposes. For the above example, the format of the date is month-year (MMYY). If the user is a registered user, this field may be blank and PVS 102 may use the information provided by the user during registration and stored by PVS 102.

The user may request two or more stamps by concatenating a copy of the above XML purchase request for each stamp requested. For example, if 10 stamps are requested there will be 10 copies of the above XML purchase request concatenated together and sent as a batch to the PVS 102.

User system 104 then communicates the user's request to purchase postage to PVS 102 via communication network 108 (step 206). According to an embodiment, a secure socket layer (SSL) connection is established between user system 104 and PVS 102 to facilitate communication of information between user system 104 and PVS 102.

PVS 102 then receives the user request to purchase postage from user system 104 (step 208). PVS 102 may then validate the user request (step 210). For example, PVS 102 may determine if the credit-card information provided by the user is valid. PVS 102 may use services provided by companies such as Cybercash and Cybersource to perform the credit-card information validation. If the request is from a registered user who has a pre-funded account, PVS 102 may determine if the user has sufficient funds in the user's account maintained by PVS 102 to satisfy the postage request. Alternatively, PVS 102 may determine if the credit-card information for the registered user is stored by PVS 102 or provided to PVS 102 by the user request. PVS 102 may also validate other information such as the identity of the user requesting the purchase, the serial number of the medium on which the postage indicium is to be printed, the type of postage requested by the user, and the like. If the validation process fails for any reason (step 212), the user's request may be terminated and a message may be communicated to the requesting user system 104 indicating that validation of the user request was not successfiul (step 214). A reason why the validation failed may also be provided.

If validation is successful, PVS 102 then generates information for printing an indicium for each stamp requested in the user postage request (step 216). According to an embodiment of the present invention, the information for printing the indicium generated by PVS 102 is along the lines specified in the IBIP specifications published by the USPS. For each indicium, the information for printing the indicium may include a bitmap of the indicium, a graphical image of the indicium, data representing the indicium, raw data corresponding to the indicium, or other information which facilitates printing of the indicium.

According to an embodiment of the present invention, the information for printing the indicium has a data structure in XML format. This indicium XML data structure is then communicated from PVS 102 to the requesting user system 104 via communication network 108 (step 218). The XML format for the indicium data structure of one stamp may be as follows:

<Indicium>

<MeterNumber>042N50000061</MeterNumber>
<RateClass>1100</RateClass>
<FIM>0<FIM>
<LPO>Warrenton, VA</LPO>
<Amount>330</Amount>
<Matrix>AgFA4gEAMDQyTr3w+gIikQEAAEoBAP8uMQE

AAAAAHh0AAACuBwAAAAAesQ0AMTEwMKHVkp9AoLIvuCxwwowCZT35n
5nxxFKfC4VU6s3i22eQbgPaFQCH53g=</Matrix>

</Indicium>

where:

<MeterNumber>042N50000061</MeterNumber> is the unique serial number of the mini-PSD (or MPSD) used for generating the indicium data structure. The MPSD is a PSD in a pool of PSD resources.

<RateClass>1100</RateClass> is a value corresponding to a rate class, for example “First Class”;

<FIM>0</FIM> is a reserved field set to 0,

<LPO>Warrenton, VA</LPO> is an optional origin address;

<Amount>330</Amount> is an amount of postage in 1/1000 of US dollars, for example, 330=$0.33; and

<Matrix>AgFA4gEAMDQyTr3w+gIikQEAAEoBAP8uMQEAAAAA Hh0AAACuBwAAAAAesQ0AMTEwMKHVkp9AoLIvuCxwwowCZT35n5nxxFKfC4VU6 s3i22eQbgPaFQCH53g=<Matrix> is Base 64-encoded binary data representing the indicium data (89 bytes) that is printed as the machine-readable portion of the indicium.

In response to each XML request for a stamp sent by the user, a copy of the above indicium XML data structure is sent by the PVS 102 to the user 104. For example, if 10 XML requests are received as one message from a user, then 10 instances of the above indicium XML data structure are concatenated together and returned to the user. These 10 indicium XML data structure instances represent 10 stamps to be printed.

At step 220, the requesting user system 104 then receives the XML data structure from PVS 102. The information received in step 220 may then be used to print the indicium (step 224). For example, a printer device coupled to user system 104 may be used to print the indicium (or indicia). According to an embodiment of the present invention, user system 104 may process the information received from PVS 102 before printing the indicium according to step 224. The indicium may be printed on any suitable medium such as a label, paper, sheet of labels, envelopes, cards, directly on the mail piece/package, or other like media. One or more indicia may be printed at a time. In alternative embodiments of the present invention, the user may store the information for printing the indicia on a storage medium, such as a memory disk, for subsequent printing.

In order to reduce fraudulent imprinting of the indicium, the medium on which the indicium is printed may be configured to possess special features which provide enhanced security against fraudulent misuse. For example, the indicium may be printed on labels which may contain any or all of a variety of security features, such as bar-coding, micro-printing, watermarking, use of fluorescent strips, serrated edges, taggants, and the like.

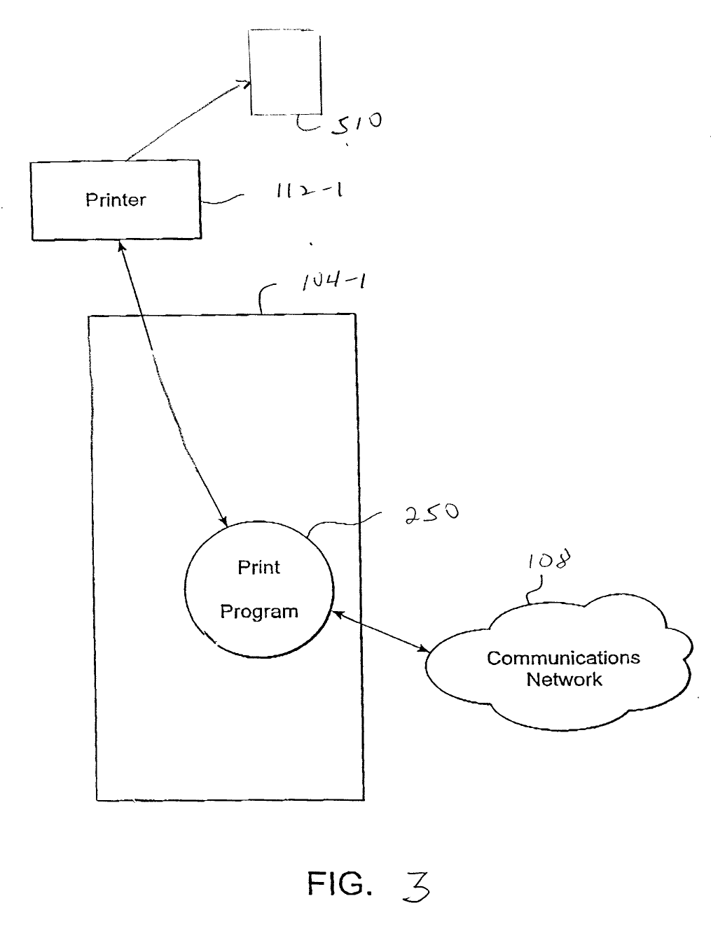

Several different techniques may be used for printing the indicium (or indicia) according to step 224. FIG. 3 illustrates a print program, including an ActiveX control and/or print.dll, operating on the user computer 104-1 of one embodiment of the present invention. The ActiveX control and/or print.dll is downloaded once. In an alternative embodiment the ActiveX control and/or print.dll may be downloaded each time the user logs onto the website or at specified intervals or known events in order to provide the latest version on the consumer's machine. After downloading, the ActiveX control and/or print.dll runs automatically when needed, and requires no further intervention by the user. The code for an embodiment of the present invention is given in U.S. Provisional Patent Application 60/216,653, filed Jul. 7, 2000, which is herein incorporated by reference in its entirety.

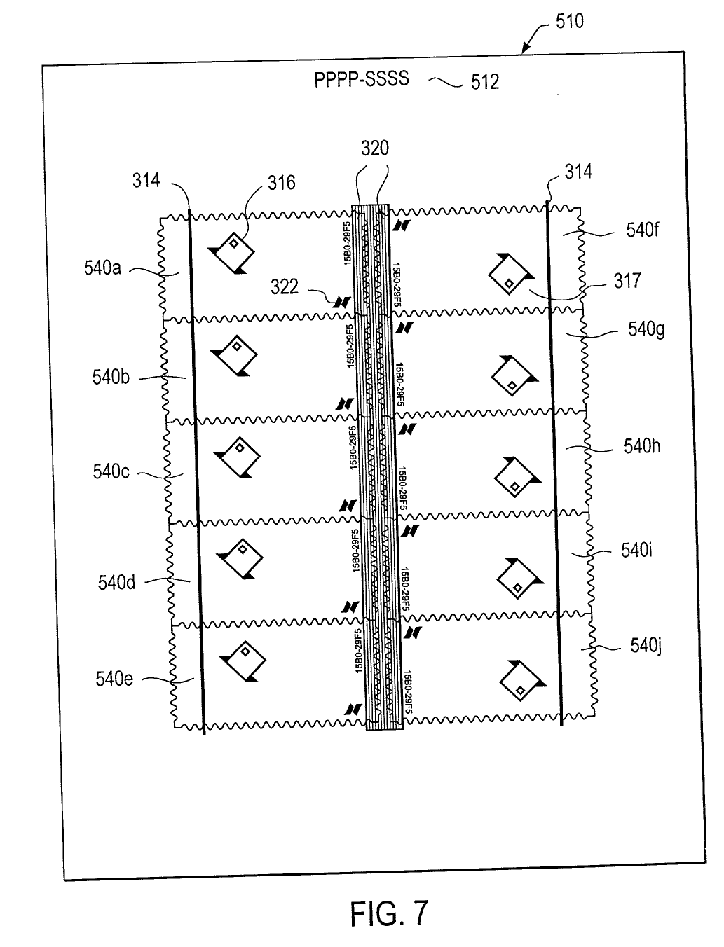

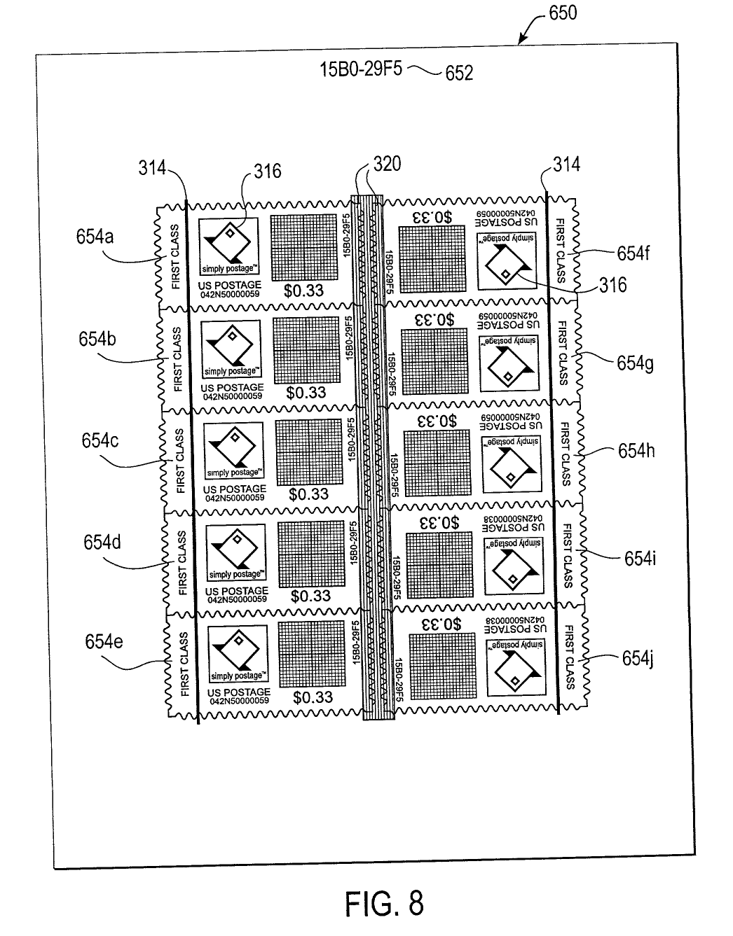

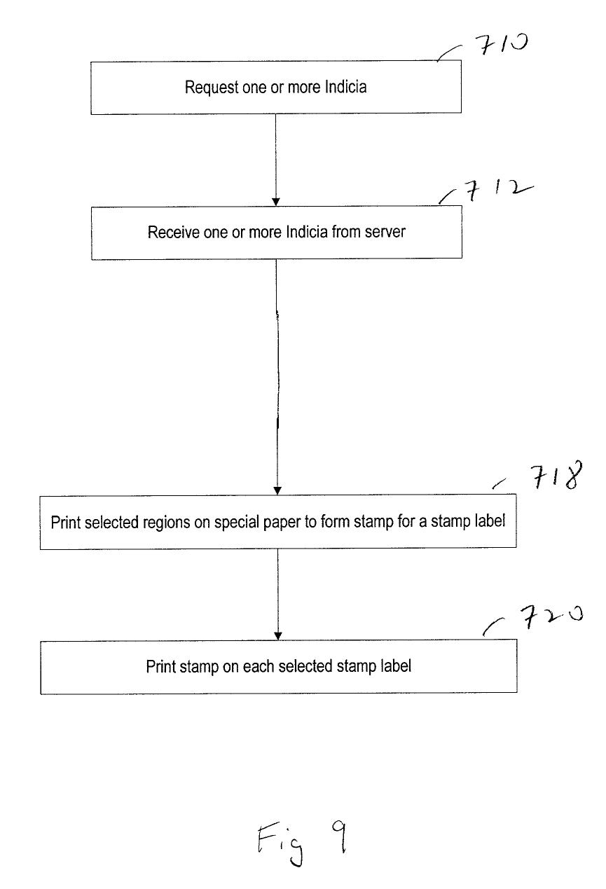

The ActiveX control operates in conjunction with the web browser on the user's computer 104 in order to transfer XML messages between the user 104 and the PVS 102. Also the ActiveX control extracts and processes the stamp information of the XML message received from the PVS 102 and sends the stamp information to the printer 112-1. The stamp(s) are printed by the printer, for example, on a pre-printed sheet 510 (FIG. 7) to give a set of stamps 650 (FIG. 8). In some embodiments, the print program may include a scale control program.

In another embodiment the print program 250 may include, for example, a print.dll, a Java applet, or VBScript, or JavaScript, C or C++program and may be downloaded by the user or automatically to permit operation of the printer and/or peripherals, such as a weigh scale. In one embodiment, the print program 250 is downloaded in complied format.

As stated above, the indicium may be printed on a label, paper, or other like medium or even on the mail piece/package itself. FIG. 4 illustrates an example of an individual pre-printed label 310 of one embodiment of the present invention. The label 310 has serrated edges 312, which add a security feature to the individual label as well as provide the “look and feel” of an outline of a conventional U.S. postage stamp. Label 310 has a pink/red colored stripe 320, and a dual-parallel line of microprint 314, where each line may have microprint “Neopost” printed repetitively. The label further includes, a label serial number 318, for example, “13DA-5F45,” a logo 316, for example a logo for “simply postage™,” and a watermark 322, for example a stylized “S.” Further details related to the use of these and other preprinted items as security features are discussed in U.S. Application No. 09/611,375 filed Jul. 7, 2000, the entire disclosure of which is herein incorporated by reference in its entirety.

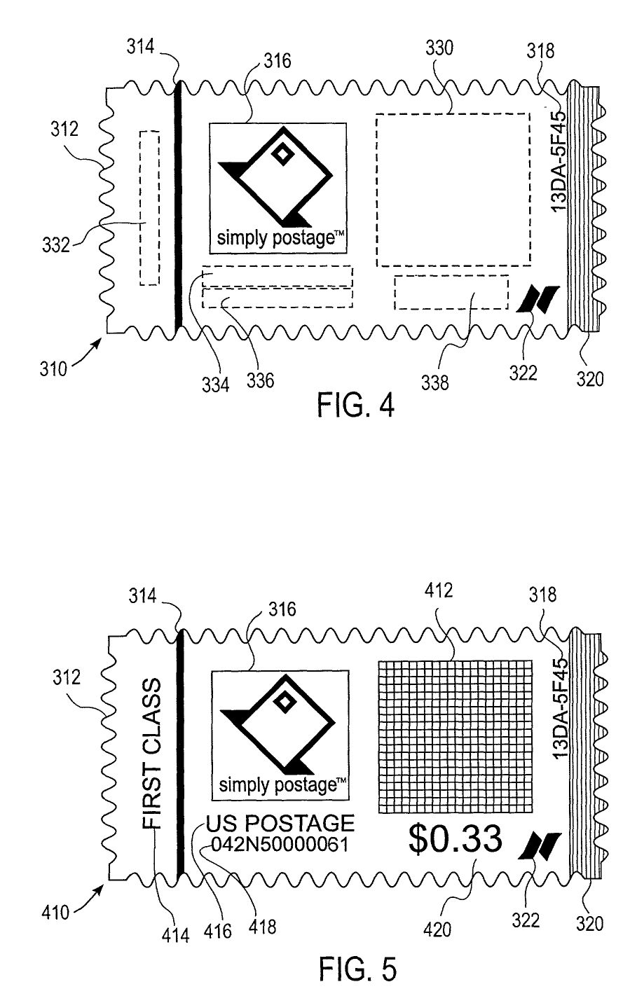

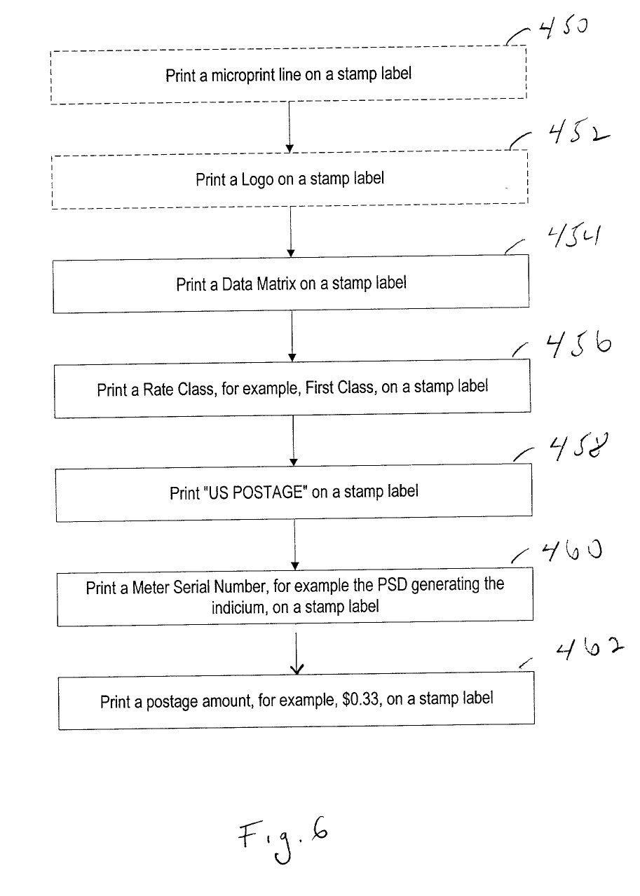

FIG. 5 illustrates an example of an individual postage stamp of one embodiment of the present invention. The individual postage stamp 410 is an example of a label 310 (FIG. 4) that has information for printing the indicium printed on it. The information for printing the indicium when printed as the indicium includes human-readable information and machine-readable information, e.g., 412. The machine-readable information 412 of stamp 410 in FIG. 5 is shown as a grid for illustration purposes only. An example of the human-readable information is includes: the postage amount, e.g., “$0.33” 420, the mail class, e.g., “first class”414, the serial number, e.g., “13DA-5F45” 318, the text “US POSTAGE”416, and the meter number, e.g., “042N50000038” 418. An example of the machine-readable information is the two-dimensional code 412 which includes the digital signature. The two-dimensional code 412 may be, for example, a matrix symbology (e.g., Data Matrix), or a two-dimensional bar code (e.g., PDF 417). In one embodiment the origin address is not printed. In an alternate embodiment the origin address is printed. The digital signature in the machine-readable information 412 may include the serial number 318, e.g., “13DA-5F45.”

FIG. 6 gives a simplified flowchart of the functions of the print program of one embodiment of the present invention. Optionally, at step 450 a microprint line, such as dual-parallel line of microprint 314 in FIG. 4, may be first printed on a blank label (In the case of FIG. 4 this microprint line already has been preprinted). At step 452 an optional logo may be printed on the blank label, such as logo 316 (In FIG. 4 again logo 316 has been preprinted on the label). At step 454 a data matrix, such as the one received from the PVS 102, e.g., the above part of the XML message received from the PVS 102 having the Base64-encoded binary data representing the indicium data (89 bytes), e.g., <Matrix>AgFA4gEAMDQyTr3w+glikQEAAEoBAP8uMQEAAAAAHh0AAACuBwAAA AAesQ0AMTEwMKHVkp9AoLIvuCxwwowCZT35n5nxxFKfC4VU6s3i22eQbgPaFQCH5 3 g=</Matrix>, is printed as the machine readable portion of the stamp in area 330 of label 310. The result is shown in machine readable portion 412 of FIG. 5. At step 456 a rate class given in the XML message, e.g., <RateClass>1100</RateClass> which may represent “First Class,” is printed in area 332 of FIG. 4, resulting in “FIRST CLASS” 414 in FIG. 5. At step 458 the text “US POSTAGE” is printed in area 334 of FIG. 4, resulting in “US POSTAGE” 416 in FIG. 5. At step 460 a meter serial number given in the XML message, e.g., <MeterNumber>042N50000061</MeterNumber>, i.e., the unique serial number of the MPSD used for generating the indicium data structure, is printed in area 336 of FIG. 4, resulting in “042N50000061” 418 in FIG. 5. Lastly, at step 462 a postage amount given in the XML message, e.g., <Amount>330</Amount>, is printed in area 338 of FIG. 4, resulting in “$0.33” 420 in FIG. 5. After step 462 a first class stamp has been printed and the flowchart may be iterated, starting at step 450, in order to print another stamp on a label. For example for the 10 labels of FIG. 7, the flowchart of FIG. 6 may be repeated 10 times. While the steps in FIG. 6 are shown in sequential order, this is for illustration purposes only. Other embodiments will have either a different sequential order or some or all of the steps may be done concurrently.

FIG. 7 illustrates an example of a sheet of postage labels 510 of an embodiment of the present invention. The sheet of postage labels 510 includes ten individual postage labels and a lot serial number 512. The ten individual postage labels, which may correspond to any of the individual labels described above, include postage labels 540a, 540b, 540c, 540d, 540e, 540f, 540g, 540h, 540i, and 540j. An individual postage label, for example, label 540a includes a pink/red vertical stripe 320, a vertical dual-parallel line of microprint 314, and a company logo 316. The watermark 322 is optional. The labels 540f-540j are similar to labels 540a-540e, except they have been rotated 180 degrees. Another description for labels 540f-540j are that they are labels 564a-564e horizontally flipped and then vertically flipped. The lot serial number 512 which is associated with the sheet of postage labels 510 is “PPPP-SSSS.” In this embodiment, the lot serial number 512 is the same as the individual label serial number however, in other embodiments the lot serial number may be different from the individual label serial number.

FIG. 8 illustrates an example of a printed postage label sheet of an embodiment of the present invention. The printed postal label sheet 650 includes, for example, a sheet of ten adhesive individual stamps 654a-654j, and a sheet, i.e., lot, serial number 652.

FIG. 9 illustrates a simplified flowchart of printing a sheet of stamps of an embodiment of the present invention. At step 710 the ActiveX control of the user system 104-1 sends an XML message to the PVS 102, where, for example, for a request for 10 stamps, the XML message includes:

<?xml version=′1.0′standalone=′yes′?>

<!DOCTYPE ExtensibleMarkupQuery>
<ExtensibleMarkupQuery Use=″NeopostSP″User=″TestPrint″Pwd=″TestPrint″
Transaction=″yes″RequestID=″0″>

<NeopostBP.bp_RequestWebStamp>

<NeopostBP.bp_RequestWebStampParams>

<LoginID>TestPrint</LoginID>
<Amount>330</Amount>
<RateClass>1100</RateClass>
<FIM>0</FIM>
<SerialNumber>1966-F8CF</SerialNumber>
<CCNameOnCard>Joe Customer</CCNameOnCard>
<CCNumber>0000111122223333</CCNumber>
<CCExp>0401</CCExp>

</NeopostBP.bp_RequestWebStampParams>
<NeopostBP.bp_RequestWebStampParams>

<LoginID>TestPrint</LoginID>
<Amount>330</Amount>
<RateClass>1100</RateClass>
<FIM>0</FIM>
<SerialNumber>1966-F8CF</SerialNumber>
<CCNameOnCard>Joe Customer</CCNameOnCard>
<CCNumber>0000111122223333</CCNumber>
<CCExp>0401</CCExp>

</NeopostBP.bp_RequestWebStampParams>

ETC...

<NeopostBP.bp_RequestWebStampParams>

<LoginID>TestPrint</LoginID>
<Amount>330</Amount>
<RateClass>1100</RateClass>
<FIM>0</FIM>
<SerialNumber>1966-F8CF</SerialNumber>
<CCNameOnCard>Joe Customer</CCNameOnCard>
<CCNumber>0000111122223333</CCNumber>
<CCExp>0401</CCExp>

</NeopostBP.bp_RequestWebStampParams>

</NeopostBP.bp_RequestWebStamp>

</ExtensibleMarkupQuery>

The PVS 102 goes through the steps in FIG. 2 and when validation is successful (step 212), generates the digital signature and information for printing the indicium (step 216) and sends an XML message back to the ActiveX control of the user system 104 (step 218). The return XML message includes:

<results>

<retvals>

<proc sp=″NeopostBP.bp_RequestWebStamp″ret=″0″/>

</retvals>
<Indicium>

<MeterNumber>042N50000061</MeterNumber>
<RateClass>1100</RateClass>
<FIM>0</FIM>
<LPO>Warrenton, VA</LPO>
<Amount>330</Amount>

<Matrix>AgFA4gEAMDQyTr3w+gIikQEAAEoBAP8uMQEAAAAAH

h0AAACuBwAAAAAesQ0AMTEwMKHVkp9AoLIvuCxwwowCZT35n5nxxFKf
C4VU6s3i22eQbgPaFQCH53g=</Matrix>

</Indicium>
<Indicium>

<MeterNumber>042N50000062</MeterNumber>
<RateClass>1100</RateClass>
<FIM>0</FIM>
<LPO>Warrenton, VA</LPO>
<Amount>330</Amount>

<Matrix>AgFA4gEAMDQyTr7w+gIobQEAAEoBAP8uMQEAAAAAH

h0AAACuBwAAAAAY1Q0AMTEwMNnd9wLtNJqS0FDYL4M0EY0iigfPkkZg8
7dpFvz/nRp06gYoLJTexWk=</Matrix>

</Indicium>

ETC...

<Indicium>

<MeterNumber>042N50000062</MeterNumber>
<RateClass>1100</RateClass>
<FIM>0</FIM>
<LPO>Warrenton, VA</LPO>
<Amount>330</Amount>

<Matrix>AgFA4gEAMDQyTr7w+gJybgEAAEoBAP8uMQEAAAAAH

h0AAACuBwAAAADO0w0AMTEwMCIgdsXmFoCtITI/dkiqm188UjbRTuA1fA
oxmsjftjPOFaVz4G1Pqjc=</Matrix>

</Indicium>
<Balance>

<Available>9303039</Available>

</Balance>

</results>

At step 712 the ActiveX control of user 104 receives the above return XML message, having indicia for 10 stamps, from the PVS 102. The print program 250 then goes through the flowchart of FIG. 6, ten times to print ten stamps shown in FIG. 8 on the labels shown in FIG. 7 (at step 718). In one embodiment the printing of each stamp occurs in a zigzag fashion, for example, 540a to 540f to 540b to 540g to 540c to 540h to 540d to 540i to 540e to 540j. Other embodiments will have different printing sequences.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. Therefore, it is to be understood that within the scope of the appended claims, the invention may be practiced otherwise than as specifically described.

What is claimed is:

1. A method for obtaining a postage stamp by a user system, comprising a processor, a memory, and a printer, from a website server over a communications network, said method comprising:
requesting said stamp from said website server;
receiving an markup language message comprising encoded binary data representing a machine-readable portion of an indicium associated with said stamp, said indicium comprising a digital signature; and
using said print program, printing said machine-readable portion on a pre-processed label by said printer.

2. The method of claim I wherein said print program is downloaded from said website server and stored in said memory.

3. The method of claim I wherein said markup language includes a Standard Generalized Markup Language (SGML).

4. The method of claim 1 wherein said markup language includes a Hypertext Markup Language (HTML).

5. The method of claim 1 wherein said markup language includes an eXtensible Markup Language (XML).

6. The method of claim I wherein in said print program includes an ActiveX control.

7. The method of claim 1 wherein in said print program includes a dynamic link library(dll) file.

8. The method of claim 1 wherein in said print program does not require a license from the United States Postal Service to execute.

9. The method of claim 1 wherein in said print program does not require a separate account from the United States Postal Service to execute.

10. A method for obtaining a postage stamp by a user system, comprising a processor, a memory, and a printer, from a website server over a communications network, said method comprising:
storing a print program downloaded from said website server in said memory;
requesting said stamp from said website server;
receiving an XML message comprising encoded binary data representing a machine-readable portion of an indicium associated with said stamp, said indicium comprising a digital signature; and
using said print program, printing said machine-readable portion on a processed label by said printer.

11. The method of claim 10 wherein said markup language includes a Standard Generalized Markup Language (SGML).

12. The method of claim 10 wherein said requesting includes an XML data structure.

13. The method of claim 12 wherein said XML data structure includes a serial number that identifies said pre-processed label.

14. The method of claim 10 wherein said print program includes an AcivteX control.

15. The method of claim 10 wherein said print program is downloaded only once.

16. The method of claim 10 wherein said print program is downloaded each time a user logs into said website server.

17. The method of claim 10 wherein said encoded binary data is base 64.

18. The method of claim 10 wherein said pre-processed label has at least one of the following security features: bar-coding, micro-printing, watermarking, fluorescent strips, serrated edges, taggants, label sheet serial number, or individual label serial number.

19. The method of claim 10 wherein said XML message further comprises a meter number, a rate class, and an amount of postage.

20. The method of claim 10 further comprising:
using said print program, printing a logo on said pre-processed label by said printer; and
using said print program, printing microprint line on said pre-processed label by said printer.

21. The method of claim 10 further comprising:
using said print program, printing said meter number on said pre-processed label by said printer;
using said print program, printing said rate class on said pre-processed label by said printer; and
using said print program, printing said amount of postage on said pre-processed label by said printer.

22. A computer program product stored in a computer readable medium for obtaining a postage stamp by a user system, comprising a processor, a memory, and a printer, from a website server over a communications network, said computer program product comprising:
code for requesting said stamp from said website server;
code for receiving an XML message, said XML message comprising encoded binary data representing a machine-readable portion of an indicium associated with said stamp, said indicium comprising a digital signature; and
code for printing said machine-readable portion on a pre-processed label by said printer.

23. The computer program product of claim 22 wherein said code for requesting comprises an XML data structure.

24. The computer program product of claim 22 wherein said XML message further comprises a postal rate class.

25. A system for obtaining a postage stamp from a central server via a communication network, comprising:
a memory;
a processor coupled to said memory for sending a user request for said postage stamp in a markup language format to said central server;
a software module stored in said memory for extracting an indicium from a markup language message received in response to said user request, said indicium including a digital signature;
a printer for printing said indicium on a pre-processed label.

26. The system of claim 25 wherein markup language is XML.

27. The system of claim 25 wherein markup language is SGML.

28. The system of claim 25 wherein markup language is HTML

29. The system of claim 25 wherein said software module includes an ActiveX control.

30. The system of claim 25 wherein said software module includes a print.dll.

31. The system of claim 25 wherein said indicium further comprising a serial number.

32. The system of claim 25 wherein said pre-processed label has at least one of the following security features: bar-coding, micro-printing, watermarking, fluorescent strips, serrated edges, taggants, label sheet serial number, or individual label serial number.
